(19) United States
(12) Patent Application Publication
(10) Pub. No.: US 2005/0066350 A1
(43) Pub. Date: Mar. 24, 2005

(54) Creating agents to be used for recommending media content

(76) Inventor: Petrus Gerardus Meuleman, Eindhoven (NL)

Correspondence Address: Corporate Patent Counsel;Philips Electronics North America Corporation, PO Box 3001, Briarcliff Manor, NY, 10510, US

(21) Appl. No.: 10/495,281

(22) PCT Filed: Oct. 28, 2002
(86) PCT No.: PCT/IB02/04499

(30) Foreign Application Priority Data
Nov. 16, 2001 (EP) 01204393.1

(51) Int. Cl. H04N 7/16; H04H 9/00

(52) U.S. Cl. 725/10; 725/9

(57) ABSTRACT

A method and a system for the creation of agents to be used for recommending media content to a user (207). The agent comprises a profile of media content and can further comprise an algorithm for recommending media (201) on a media system (208). The media system (208) can be a VCR, a TV, a set-top box, a DVD player, a radio or a personal computer. The method includes the steps of validating an agent in an off-line system (210), transferring agents forth and back between the off-line system (210) and an on-line system (203). The step of validating includes the steps of composing a test set of historical content, estimating scores of an agent in the test set, determine average difference between agent scores and historical relevance feedback, determining performance of an agent using average difference of all agents over the test set and reliability of historical relevance feedback. The method further includes the steps of nominating agents in the on-line system (203), selecting agents and copying agents forth and back between the on-line system (203) and the off-line system (210); importing, generating, training, ranking, nominating and deleting agents in the off-line system (210).

This invention relates to a method of creating agents to be used in a system for recommending media content.

The present invention also relates to a computer system for performing the said method.

The present invention further relates to a computer program product for performing the said method.

The patent U.S. Pat. No. 6,005,597 discloses an embodiment of a method and an apparatus for program selection. It uses the viewing preferences of a viewer to create a dynamic viewer profile, which is used automatically to rate available programs. The available programs are presented to the user in descending order of predicted interest in the form of on-screen menus or preview windows on the screen. The patent U.S. Pat. No. 6,005,597 obtains data about titles and topics of available TV programs from web sites that list topics and descriptive information about programs. The invention disclosed in U.S. Pat. No. 6,005,597 monitors the viewer's habits and builds an evolving model of the viewer's preferences such as the name of the program, the topic area, the time watched, etc. The evolving model of the viewer's preferences also combines feedback scores such as “Yes” or “No” to compute the user's “Topic Interest” for an actually viewed program in order to compute the viewer's preferences. Additionally collaborated simulated viewer profiles with viewer preference information currently absent in the viewer profile can be combined to compute the actual viewer's preferences. Best matching considerations of viewer profiles are considered too when the viewer profile is periodically updated.

However, the above prior art method involves the problem that the update of viewer profiles may conflict with the use of them. Generally, the update of viewer profiles and the use of viewer profiles may have conflicting interests in how to modify the data of the viewer profiles.

A change of a viewer profile can be needed apart from the system recommending media for a fine-tuning of the viewer profile, for a modification and a test of a viewer profile before the viewer profile can be released to give recommendations of media on another system.

It is convenient to provide a system or a system part where experiments, test, validation etc. of new types of media content and user profiles can be done before the release of user profiles to an on-line system, where the user profile is actually used to recommend media content to a user.

The object of the present invention is therefore to provide a system and a method where profiles representing user preferences in the form of agents can be modified, etc. apart from a media recommender system.

The object is achieved by a method of the type mentioned above, said method comprising the steps of
validating a second agent in a second system, and
transferring information about the second agent in the second system to the first system.

Consequently, the validating of an agent is done in a second system separated from the first system, wherein information about an agent is transferred from the second system to the first system, where a recommendation of media content may be given.

In one embodiment of the method, the method further comprises
transferring information about the first agent in the first system to the second system

Hereby the second system may take advantage of well performing agents from the first system.

Another preferred embodiment of the method is described in claim 3.

Hereby an agent may be validated in the second system by first composing a test set of media content items with relevance feedback data, and secondly for an agent estimating scores in the test set of media content items, and thirdly for an agent determining differences between scores of agents and relevance feedback data for media content items in the test set, and as the fourth step, with all agents determine average difference for the test set of media content items, and finally, for an agent estimate performance in response to the average difference, the differences of the agent, and the reliability of the relevance feedback data of the media content items in the test set of media content items.

Another preferred embodiment of the method is described in claim 4.

Hereby the best performing agents may be nominated on the first system, the first system may select and copy a best performing agent from the second system, an agent may be imported to the second system from an external source, the second system may improve an agent in that an agent is generated or trained, the second system may rank and nominate the best performing agents, an agent may selected and copied from the second system to the first system, and the second system may delete the worst performing or obsolete agents.

Another preferred embodiment of the method is described in claim 5.

Hereby the agent may be used to recommend media preferred by the user to be presented, shown, played on a media system.

Other preferred embodiments of the invention are described in claims 6 and 7.

Hereby, it is an advantage of the invention that the on-line system may recommend media (based on agents) and that the on-line system does not conflict with the validation, etc. of the off-line system's same, copied, created or similar agents.

It is therefore another advantage of the invention that a recommendation of media content on the on-line system is not wrongly affected by non-validated agents.

Other preferred embodiments of the invention are described in claims 8 and 9.

The profile of media content and further the algorithm of the agent may be used to suggest recommendation of media content to a user.

In an other preferred embodiment of the invention the media system is one from the group comprising VCR, TV, set-top box, DVD player, radio and personal computer. Hereby the media system of the invention may be run on any of these units.

The invention will be explained more fully below in connection with preferred embodiments and with reference to the drawings, in which:

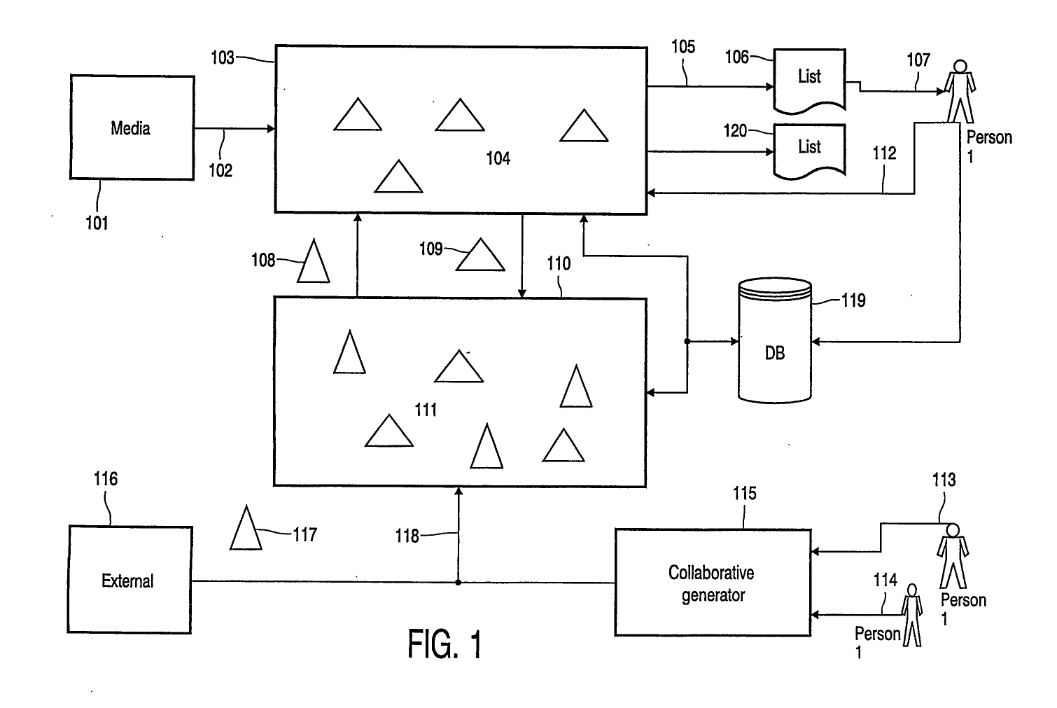

FIG. 1 shows a general system for recommending media;

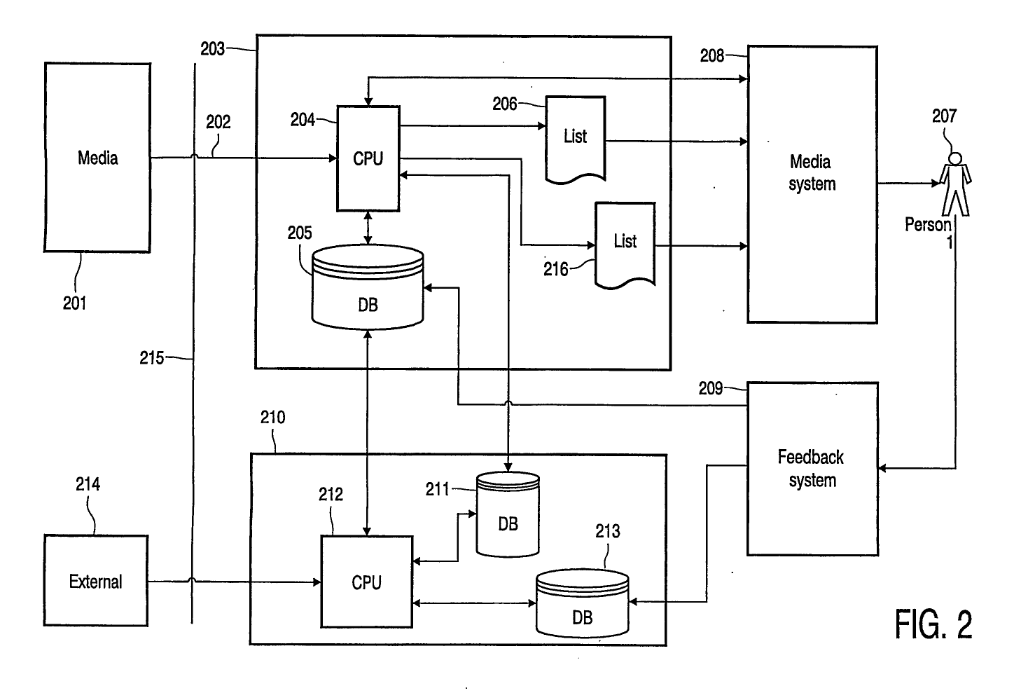

FIG. 2 shows a media system with a user, a media provider, an on-line system, an off-line system, an external source and a feedback system; and

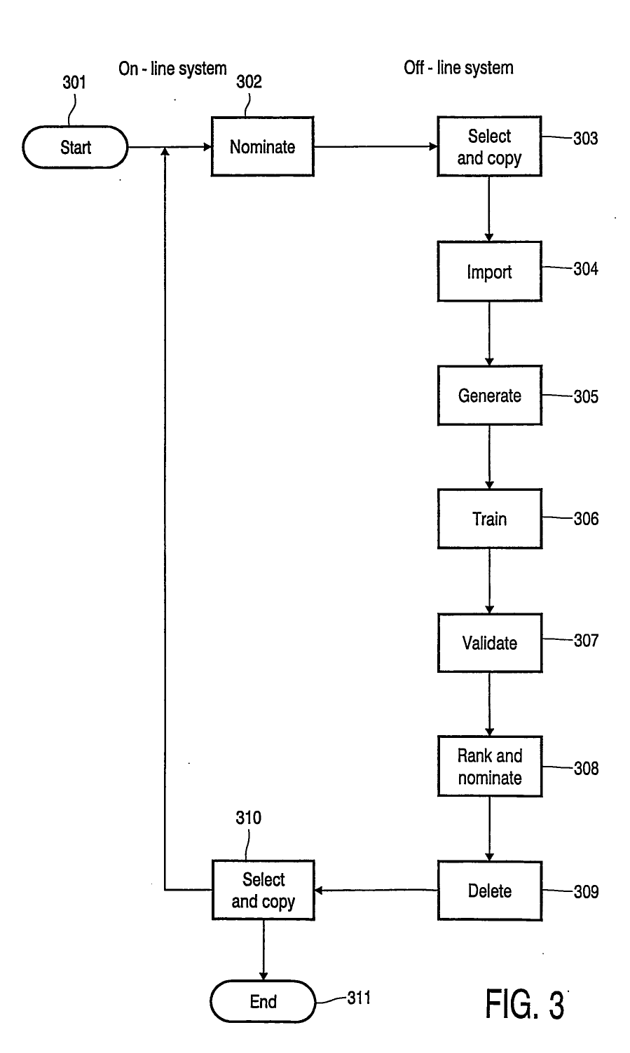

FIG. 3 shows a method of creating agents to be used in a system for recommending media content.

FIG. 1 shows a general system for recommending media. The figure is shown only for brief illustrative purposes and is shown for generality to avoid the discussion of hardware design of different systems at this point. It shows briefly how agents flows e.g. may be transferred forth and back between reference numeral 103, an on-line system, and reference numeral 110, an off-line system, and that agents may further come from reference numerals 116 and 117, external sources, to reference numeral 110.

The basic idea of having two systems for recommending media is to use agents in that the agents of each system can be modified and used in each system seperately. Agents in preferred embodiments of the invention may have the content of their profile changed in that one system retrieves improved agents or gets other information to manipulate agents in various ways to improve the general performance of an agent, whereas the other system may give recommendation of media based on agents. As just mentioned, the agent may be used to recommend media content on a media system shown in reference numeral 208 of FIG. 2. Media content may be media that can be presented on corresponding media system. The media system may be an intelligent set-top box, an intelligent VCR or a Personal Computer, a DVD player, a radio or any other electronic device, which can present media content.

The media content may refer to the form of live media content like a TV program, a video available to be seen on demand, an interactive live broadcasted TV on the internet, internet TV, internet sites only available when e.g. a certain event happens, a movie, radio broadcastings or any other media which may be watched during the broadcast, or it may be a media content that may be stored on the media system for a later presentation.

Returning to FIG. 1, reference numeral 101 may be a media provider. Reference numerals 103, the on-line system, and 110, the off-line system, may be understood as two cooperating systems for a general manipulation of agents. The basic idea of having an on-line system and an off-line system is to separate the work when agents are manipulated in various ways by the two systems, as it is convenient that the off-line system can manipulate the agents of the off-line system separately without any effects on the agents of the on-line system. As the agents of the on-line system may be used to recommend media, it would be inappropriate if an agent used for experiment was used to recommend media. The manipulation of agents in the two systems, etc. is described in the method of FIG. 3.

The triangles 104, 108, 109, 111, 117 may show how agents are manipulated in the systems. External agents may further be transferred to reference numeral 110 from an external source 116 by means of reference numeral 118. The external source of agents 116 may be an external website accessible by means of the Internet. Agents may further be transferred to reference numeral 110 from a collaborative generator of agents 115. The collaborative generator of agents may have its own processing power to create and generate agents based on information about media content, reliability of feedback, relevance feedbacks from users, reference numerals 113 and 114, outside the systems, etc. Correspondingly, relevance feedback from a user, reference numeral 107, may be fed back by means of reference numeral 112 to the on-line system and or to reference numeral 119, a common database for the on-line and the off-line system.

Reference numeral 119, the common database for the on-line and the off-line system, may be used to keep track of relevance feedback given from users, i.e. a relevance feedback database with historical information about media content selected by users. It may further comprise information about implicit feedback and or explicit feedback, as will be described in the feedback system of FIG. 2.

Reference numeral 106, a list, may be the list of agents that are used and transferred by means of reference numeral 105 to recommend media content to the user 107.

Reference numeral 120, another list, may be a list of recommendations of media content and may be used to show recommended media content to the user 107.

FIG. 2 shows a media system with a user, a media provider, an on-line system, an off-line system, an external source and a feedback system.

Reference numeral 201 may be a media provider providing media content available. Reference numeral 201 may comprise more than one media provider. Reference numeral 201 may also contain information about media content embedded in the reference numeral 202, the signal from 201.

Media content may be a live media content like a TV program, a video available to be seen on demand, an interactive live broadcasted TV on the internet, internet TV, internet sites only available when e.g. a certain event happens, a movie, radio broadcastings, or any other media which may be watched during the broadcast, or it may be a media content that may be stored on reference numeral 208, a media system—i.e. PC or a VCR—for later playback and presentation.

The information about media content may be embedded in 202, the signal from the media provider. The information about media content may be retrieved and derived from the meta-data in the media provider information. The media provider generally provides media content to the media system. The meta-data may contain textual and codified information about media content. In the television world the standardised DVB-Service Information contains information on electronic programme guides as information about media content. The information about media content may also be derived from text TV information sent during the broadcasting of TV programs. Further the information about media content from may be fetched and derived from web sites. The information about media content may contain information about genre, type, duration, topic, title, begin, etc of available media content.

Reference numeral 203 may be the on-line system for recommending media.

Reference numeral 204 may be the CPU or the processing power of 203. Reference numeral 204, the CPU, may update reference numeral 205, a database for agents. The term agent, the content and the use of it will be described in more detail at the end of the description of the current figure.

On the basis of agents—a recommendation of media—may be sent direct to 208, the media system.

Alternatively, reference numeral 216, a generated list, may be a list of recommendations of media content, the list may be used to recommend media content to the user 207 on the media system, reference numeral 208.

Reference numeral 206 may be a listing of agents. It may be in the form of a list and or in a form that can be understood by other electronic devices like 8 for further processing on a system like 208.

Reference numeral 202 is the signal from the media provider, it may be signals for downloadable videos to be seen on demand, for Internet data transmission, for TV programs, for the request of a movie, for radio broadcastings or any other media content that may be stored or presented on the media system 208. The reference numeral 204, the CPU, may send reference numeral 202, the signal from the media provider to reference numeral 208, the media system.

Reference numeral 208 is the media system, it may be an Internet pc, a set-top box, a TV, a Video Cassette Recorder, DVD player, radio, etc. Generally, reference numeral 8 may be a system that can present the media content from the media provider either live or from a recording of media content. The media system may further have a CPU or another processing power in that it may perform retrieval of relevance feedback—i.e. a user's rating of the media content—and or recording of media content for a later presentation on the media system. The user's rating of the media content may be done by input means. The input means for rating media content presented on the media system may be integrated in reference numeral 208—the media system. It may be a keyboard, a mouse, a remote control, an interactive menu with clicks on an onscreen menu, a joystick, voice input, recognitions of gesture or by any other means, where rating can be given from a user 207.

The user or users may watch or listen to the presented and or selected media content on 208.

Reference numeral 209 is the feedback system, where it may be supervised how the user or the users interact with the media system 208 in an explicit or an implicit way. The implicit way of feedback may be, when users interact with the media system 208 in the form of zapping, adjusting volume, changing the tone and the balance of tone, looking up text TV information, etc. The explicit way of feedback may be when the feedback system retrieves information about a direct score of a user of a media content item presented, and it may be explicit feedbacks like “I love this programme”, “I hated this”, “I rate this with 0.85”, etc.

Further implicit feedbacks are supervised by reference numeral 209, the feedback system, e.g. when the user switches to a TV channel or to a program and to which TV channel or TV program. It may be supervised—when the media system is a PC with access to the Internet—how and to which Internet sites the user 207 surfs. It may further be supervised how the user switches between different internet sites or homepages, correspondingly the URL's of the sites are supervised and the URL's of these sites are stored by means of 212, the CPU, on a database 213 to have a historical reference to and how the user actually interacted with the Internet, and which media content from the Internet or from another media provider was actually retrieved for presentation. The database 213 may further be the database for relevance feedback from the user.

Reference numeral 209, the feedback system may be integrated in the media system 208, or it may be designed in a dedicated hardware in the form of an electronic module for the general supervision of how a user interacts with a media system.

In the event that reference numeral 209, the feedback system, is not integrated in the media system 208, feedback data may be sent to reference numeral 205, the database of the on-line system of agents.

Reference numeral 215 is the user connection point to the media provider 201. It may be an antenna outlet for TV or radio, a modem or ADSL connection or the like connection to the internet, an antenna outlet from a satellite receiver, a SCART connection to a TV and or to a VCR, etc.

Reference numeral 210 may be the off-line system or part of the system for recommending media—as opposed to reference numeral 203 this system works off-line. The term off-line is taken to mean that the system 210 merely processes in the background as opposed to 203, the on-line system, where the user of the media system 208 merely needs, requests and delivers data during the use of media content. In other words, 210 may not necessarily need to respond in real time to the user 207, thereby 210, the off-line system, may be said to be more off-line as opposed to 203, which may have to be more on-line in its way of real time response to user actions etc.

Reference numeral 211 in 210 may be a database for agents. The term agent will be described in more detail at the end of the description of this figure.

Reference numeral 212 may be the CPU or the processing power of 210, as it may use the processing to perform various manipulations on agents described in more detail in FIG. 3. Reference numeral 212 handles the filling, updating, validation, importing, transferring, training, ranking, deletion, etc. of agents in reference numeral 211, the database for agents. This will be described in more detail in FIG. 3. Reference numeral 212 may further handle the transfers forth and back of agents between the two different systems as reference numerals 210 and 203.

Reference numeral 213 in 210 may be a database for user relevance feedback for media content actually watched. The relevance feedback and other information about media content presented, watched and rated may be retrieved from reference numeral 209, the feedback system to reference numeral 213. In other words, 213 may comprise historical information about user interactions, what was presented, rated etc. with and on the media system 208.

Reference numeral 214 may be input of external agents to reference 210, the off-line system. The external agents may come from an external website, or the external agents may come from the collaborative generator of agents like reference numeral 115 of FIG. 1. The external agents may be received by reference numeral 212 for processing before they may be released and put into actual use by the off-line system. Reference numeral 214 may generally comprise the transfer of external agents mentioned in reference numerals 115 and 116 of FIG. 1.

Generally, reference numerals 203, 208, 209 and 210 as a whole may also be considered as the system for recommending media based on agents. 203, 208, 209 and 210 may be integrated in one box comprising the media system, as it may be convenient for the user to have the whole system—which will be regarded of the user as the media system—as one box of electronics.

The agent may comprise a profile of media content preferred and an algorithm for matching the profile of media content. It may be the case that the agent only comprises a profile of media content.

As an example, assume that the information about media content comprises the information as shown in the following figure:

| Field name | |
|---|---|
| (attributes) | Attribute value |
| Title | Race for Freedom |
| Channel | Net1 |
| Start time | 21:20:00 |
| Duration | 73:15 |
| Genre | Movie |
| Sub-genre | Action |
| Keywords | Car racing, action, gunfight, |
| | kidnapping |
| Synopsis | Speedy Johnny, a formula 1 |
| | champion, escapes from his |
| | kidnappers |
| Country of origin | USA |
| Original language | English |
| production year | 1982 |
| Director | . . . |
| Actor 1 | . . . |
| . . . | . . . |

The example of information about media content may be like the attribute based content description shown in pseudo DVB-SI format.

The algorithm for matching the profile of media content may be stored in a set of logical rules. The rules may comprise logical constructions in the format:
rule: IF antecedent_clause [AND antecedent_clause] THEN consequent_clause

Most clauses may be made of the same attributes as the content description above, an example may be:
clause: attribute=attribute_value

An example of a rule-based profile may look like this:
DEFAULT score=0.3
IF genre=sport AND sub_genre=soccer THEN score=0.65
IF preferred_channel=true THEN score=score+0.2
IF channel=bbc* THEN preferred_channel=true
bbc* may refer to any bbc channel—i.e. bbc1, bbc2, etc.

In the case that this profile is matched (by the agents matching algorithm) with the information about media content, such as the following example
genre=sport,
sub_genre=soccer and
channel=bbc1.
the result may be:
score=0.85 (as 0.2 is added to 0.65)
which is the resulting recommendation score for this media content. This will be referred to as score in the following.

The above example shows how the agent may comprise a profile of media content preferred (i.e. sport, soccer and bbc1) and an algorithm (if- and- then, etc.) for matching the profile of media content.

The “if- and- then” construction is part of the rule, not the algorithm. The algorithm may be able to reason with the rules, i.e. check whether the antecedent_clauses of a rule are true, in order to perform the result of a true statement, i.e. to make the consequent clause true. Any result of a rule may cause evaluation of further rules. The way of doing such evaluations may be embodied in the algorithm, which may be called an inference engine or reasoning engine.

The example may further be extended with more sophisticated rules to be combined into the algorithm and with more field names and more attribute values for the field names.

In other words, when available media content—in the form of information about media content—matches the profile on the agent, i.e. media content available or media content to be sent in the near future on the media system which have the same or a similar genre, sub-genre, keywords, language, preferred duration, etc., it may be put on a recommended list of information about media content which may be presented to the user of the media system and may then be preferred by the user of the media system.

FIG. 3 shows a method of creating agents to be used in a system for recommending media content. On the left hand side of this figure, the steps of the on-line system of the method are shown. On the right hand side of the figure, the steps of the off-line system of the method are shown.

In step 301, the method is started. If it is the first time the systems are powered up, different initialisations of system variables, agents, etc. are performed to set these to an appropriate working default state. In order to make the method work properly, different information from outside of the system (external agents, user relevance feedback score, etc.) may be needed to give the method data to work with. It is assumed that these circumstances are present in the following steps. After this starting step, the method proceeds to step 302.

In step 302, agents may be nominated by the on-line system. The on-line system may decide which agents are nominated as candidates to be transferred to the off-line system. In the actual transfer of an agent or agents to the off-line system the agent or information about the agent(s) may be transferred to the off-line system. The information about an agent may be the pure or raw data expression of the agent comprising the profile of media content and the algorithm for recommending media. The on-line system may have one measure for the success of each on-line agent: its average performance on recent relevance feedback data. The process of calculating this performance is identical to the process in the off-line system, which is described in step 307.

In a simplified form the on-line system may only allow the best performing agent or agents to be transferred to the off-line system. The best performing agents are nominated. The underlying hypothesis is that the possibility is higher for an agent to have a good performance in the off-line system if the starting material had a good behaviour in the on-line system.

If a nominated agent is selected by the off-line system, a copy of the agent is transferred to the off-line system. The copied agent itself may remain active in the on-line system, but the agent administration of the database of the on-line system may mark this agent as being copied—i.e. reference numeral 205, the database of the on-line system may be updated with this information. This is to prevent the same agents being transferred to the off-line system over and over again. This mark may be removed only after the agent has been changed considerably in the on-line system.

In step 303, agents may be selected and copied from the on-line system to the off-line system by the off-line system. The selection of nominated agents from the on-line system may further be based on other sophisticated criteria, which may differ from those in the nomination process mentioned above. In a preferred embodiment of the invention, the agents with the highest performance may be selected and picked from the on-line system by the off-line system, only agents which are not marked as being previously transferred to the off-line system may be selected.

The number of agents to be picked may be determined as follows. The off-line system may try to keep the number of agents in its population (i.e. the number of agents in the database like reference numeral 211 of FIG. 2) at a fixed number of agents within certain limits, which may be a system parameter of the off-line system. During each cycle (i.e. the execution of the entire method in this figure) a fixed percentage of the agents may be deleted—i.e. it may be the agents with the worst performance—i.e. it may be the agents of highest age, oldest or obsolete style of content, etc. The open positions for agents in the database—i.e. space that may have become free in that some agent may have been deleted—may be taken over by agents from external sources (reference numeral 214 of FIG. 2), from agents picked and transferred from the on-line system, newly generated agents (see step 305 of this method), and it may further be taken over by agents that are modified agents based on old agents. The taking over of space freed in the database may be performed in the above-mentioned order of priority.

In step 304, agents may be imported from external sources by the off-line system. In reference numeral 214 of FIG. 2 agents may be available on and from websites accessible through the Internet. The user of the on- and or off-line systems or the media system may select interesting candidate agents, which he may think could be interesting to use in his media system. He may have the possibility to have the profile of media content of the agent presented on the media system before he may actually decide to import the agent to the off-line system.

In reference numeral 115 of FIG. 1 agents may further be available from a collaborative generator of agents, generally the collaborative generator of agents may have its own processing power to create and generate agents based on relevance feedback from users, information about media content, reliability, etc. as discussed in step 307 of this method.

In another preferred embodiment of the invention, a third party may have the authority to force external agents to be imported and thereby transferred to the database of the off-line system.

Imported agents may generally be put into the database of the offline system as the off-line system may have to test and to validate the agent or agents before any transfer of agent(s) to the on-line system may be allowed to take place.

In step 305, agents may be generated by the off-line system. Several methods of generating new agents may be possible i.e. it may be possible to start with an agent with an empty profile.

An agent algorithm may be designed to derive general knowledge from specific examples in the relevance feedback history, i.e. relevance feedback database, and or information about media content. If the relevance feedback history indicates that the user appreciated a lot of football programmes, the empty agent may generate a rule of the algorithm “I love football”. The empty body of the agent as well as some initial algorithm may be available before the agent may be said to be ready for use, validation, test, training etc.

The rules of the algorithms for recommending media may be generated randomly or pseudo randomly. Profiles of media content may further be generated randomly or pseudo randomly. The algorithm for recommending media and profiles of media content together comprises an agent.

The rules in the algorithms for recommending media may be represented as bit strings. By taking copies of two well performing agents with bit-represented profiles of media content and or bit-represented rules in the algorithms for recommending media, crossover operations (Boolean bit manipulations like and, or, not, etc.) may be performed to exchange and modify bit stream part or parts between the copies. It may be done similar to genetic algorithms and genetic programming. An evolution or creation of an agent in the off-line system may further be performed with the validation and deletion processes acting as genetic manipulations known from the nature.

The idea in this step may be somehow to generate an agent based on historical data, randomly, genetically, logically and or in other ways, as it may be assured in the following step of this method that such an agent or such agents created in these ways through test and validation, etc. may be agent(s) that may actually behave well.

In step 306, agents may be trained by the off-line system. This training may be identical to the nomination in the on-line system, as parameters like average performance on recent historical relevance feedback and a better performing agent may be the result of a training.

The basic principle of training an agent may be as follows:

Ask the agent to give a score for media content based on the information about media content.

Retrieve from the relevance feedback database the correct answer, i.e. the user relevance feedback score.

Let the agent internally adjust its profile to match the correct answer.

The training may be a matter of machine learning as the training may be based solely on historical data without any direct user action. A rule-based agent—e.g. (see next step of this method) may add confidence or reliability levels to the logical rules of the algorithm. If a rule proves to be reliable, this confidence level increases. The rules of the algorithm may be extended with new and limiting attributes (from “I love football” to “I love football on bbc*”), or rules may be made more general by deleting attributes from rules (from “I love football” to “I love sport”).

In other words, the testing and validation of the trained agent—expressed as a result in a score of performance of that agent (as explained in detail in the next step of the method)—may be determined by testing it on historical data of the user of the on-line system. The off-line system uses a relevance feedback database with user data, containing recent user relevance feedback information on media content. During the training and test an agent may have to generate scores for a test set of media content items in the database; during the test the scores are generated without knowing the real user relevance feedback score, as opposed to the training where the real user relevance feedback score is known. The average difference between the estimated score and the user relevance feedback score may be a measure for the performance of the agent.

The management of the agent database in the off-line system—i.e. reference numeral 213 of FIG. 2—may form a part of the relevance feedback database available for training, test and validation.

In step 307, agents may be validated by the off-line system. The off-line system may have more than one measure for the validation success of each agent. The agent to be validated may be an agent as a result of any other step of this method. This step may assure that an agent is tested to be valid before any transfer to the on-line system may be performed.

In a preferred embodiment of the invention the average performance on recent relevance feedback data found relative to all other agents may be computed. The performance is calculated for agent j on a set of n feedback events—i.e. relevance feedback actually given on specific media content presented or selected on the media system of the user in the past.

The performance may take into account a reliability of each feedback event.

The reliability of a feedback or a feedback event may be an estimated score that represents the reliability of the user's rating of the media content. The reliability in the form of a score is based on the relevance feedback information—e.g. previously retrieved by means of reference numeral 209 of FIG. 2—the user's interaction with the media system and further based on the relevance feedback information about the user's rating of the same media content in the past—e.g. by input means of the media system of FIG. 2.

The reliability may indicate the reliability of the user's rating in the relevance feedback data as observed by the feedback system. An explicit rating may give a higher reliability value or score, as opposed to an implicit rating based on a user rating derived from any kind of user behaviour during a presentation of a certain media content item. In other words, explicit ratings, generally, are considered to be the most thrust-worthy, and therefore more reliable than implicit ratings.

Presentation of the media content or presentation of the media content item may be understood as playback, playing and or showing of media content on the media system. Presentation may also be understood as voice and or music emitted from the media system.

$${performance}_{j} = {\sum }_{x = 0}^{n} {reliability}_{x} ( {difference}_{jx} - average\_difference )$$

In the formula of performance, the test set consists of n media content items, with x being one single media content item from that set.

The performance—performance in the formula—of each agent j is relative to all other agents in the on-line system. For this the average difference—average_difference in the formula—for all m agents is defined:

$$average\_difference = \frac{{\sum }_{j = 0}^{m} {\sum }_{x = 0}^{n} {difference}_{jx}}{( m + 1 ) ( n + 1 )}$$

In the formula of average_difference, the average difference is computed on m agents, j being the agent from the test set.

The difference—difference in the formula—is defined as the absolute difference between the estimated score of an agent for media content x and the relevance feedback score—relevance in the formula—of media content item x.
differenceⱼₓ=|scoreⱼₓ−relevanceₓ|

The estimated score of an agent j—score in the formula—may be understood, as previously defined, as the resul-ting recommendation score for media content item x.

The test procedure for the agent population may be as follows:
Compose a test set of media content items (i.e. information about media content) with their corresponding relevance feedback scores, from the data in the relevance feedback database, i.e. from the database of reference numeral 213 in FIG. 2.
Take the information about media content and let each agent generate a score for this media content,
Take the relevance feedback score from the user and calculate the difference for each agent,
Repeat the last two steps for all media content,
Determine average difference over all agents, and
Determine performance for each agent.

In step 308, agents may be ranked and nominated by the off-line system. Generally an agent may be ranked on the basis of its expected usefulness for the on-line system. In a preferred embodiment of the invention an agent may be ranked on the basis of the performance estimated in the foregoing step. The higher the performance of an agent is, the higher the ranking of the agent may be.

Multidimensional ranking of agents may be a possible way of ranking too. A separate nomination process may be the case to reduce the number of dimensions to be considered in this type of ranking. The nomination process may further comprise the simple update of a ranked list of agents in the database in the off-line system.

In other words, well performing agents of the off-line system—with high performance—may be nominated as candidates for transfer to the on-line system and may further be used for further improvements.

In step 309, agents may be deleted by the off-line system. Only the best agents will survive, so the worst performing may be deleted. Many other criteria may be imagined for the deletion of agent performance, age in off-line system, content being obsolete etc.). A fixed amount of agents may be deleted in each cycle.

In step 310, agents may be selected and copied from the off-line system to the on-line system by the on-line system. The on-line system may decide how many agents to import. The ranked list from step 308 may be read by the on-line system, and it may be used by the on-line system to select and copy agents from the off-line system. The on-line system may simply pick the agents with the best performance from the list, but only the one or ones that are not marked as being copied before. The import of an agent consists of making a copy from the agent in the off-line system's database. When an agent is selected by the on-line system, the agent is transferred to the on-line system from the off-line system. In the actual transfer of an agent or agents to the on-line system the agent or information about the agent(s) may be transferred to the on-line system. A copy of the agent may remain in the off-line system. This copy may be marked, and will not be nominated again until it is changed considerably. This is to prevent that the same agent is copied over and over again.

As long as the systems are turned on and working i.e. reference numerals 201, 203, 208, 209 and 210 of FIG. 2 work properly the method will proceed and return to step 302.

A computer readable medium may be magnetic tape, optical disc, digital video disk (DVD), compact disc (CD or CD-ROM), mini-disc, hard disk, floppy disk, smart card, PCMCIA card, etc.

1. A method of creating agents to be used in a first system (103, 203) for recommending media content (120. 216) characterized in that the method comprises the steps of:
validating (307) a second agent (111) in a second system (110, 210), and
transferring information about the second agent in the second system (110, 210) to the first system (103, 203).

2. A method according to claim 1, characterized in that the method further comprises the step of:
transferring information about a first agent (109) in the first system (103, 203) to the second system (110, 210).

3. A method according to claim 1, characterized in that the step of validating (307) the second agent comprises the steps of:
composing a test set of media content items with relevant feedback data;
estimating a score of the second agent in response to the test set of media content items;
determining for the second agent a difference between the agent score and the relevant feedback data for media content items in the test set;
determining an average difference between the second agent score and the relevant feedback data for media content items in the test set; and
estimating the performance of the second agent in response to the average difference, the difference of the agent, and the reliability of the relevant feedback data of the media content items in the test set.

4. A method according to claim 1, characterized in that the method further comprises the steps of:
nominating (302) the first agent (104) in the first system (103, 203),
selecting and copying (303) the first agent (104) from the first system (103, 203) to the second system (110, 210),
importing (304) a third agent (117) in the second system (110, 210) from an external source (116, 214),
generating (305) a fourth agent (111) in the second system (110, 210),
training (306) at least one of the first, second, third and fourth agent (111) in the second system (110, 210),
ranking and nominating (308) at least one of the first, second, third and fourth agent (111) in the second system (110, 210),
selecting and copying (310) at least one of the first, second, third and fourth agent (111) from the second system (110, 210) to the first system (103, 203), and
deleting (309) at least one of the first, second, third and fourth agent (111) in the second system (110, 210).

5. A method according to claim 1, characterized in that the method further comprises the step of:
using the first agent (104) for a recommendation in a media system (208).

6. A method according to claim 1, characterized in that the first system (103, 203) is an on-line system that is used to recommend media content to a user (107, 207).

7. A method according to claim 1, characterized in that the second system (110, 210) is an off-line system that is used to validate agents (111).

8. A method according to claim 1, characterized in that the at least one of the first, second, third and fourth agent (104, 108, 109, 111, 117) comprises a profile of media content.

9. A method according to claim 4, characterized in that the at least one of the first, second, third and fourth agent (104, 108, 109, 111, 117) further comprises an algorithm for recommending media.

10. A method according to claim 5, characterized in that the media system (208) is one from the group comprising VCR, TV, set-top box, DVD player, radio and personal computer.

11. A computer system for performing the method according to claim 1.

12. A computer program product comprising program code means stored on a computer readable medium for performing the method of claim 1 when said computer program is run on a computer.
